(19) United States
(12) Patent Application Publication
(10) Pub. No.: US 2026/0051832 A1
(43) Pub. Date: Feb. 19, 2026

(54) INDEPENDENT SLIDING MODE OBSERVERS FOR FAULT TOLERANT OPERATION OF MULTI-PHASE MACHINES

(71) Applicant: Wisk Aero LLC, Mountain View, CA (US)

(72) Inventors: Manu Geetha Somanadhan, Santa Clara, CA (US); Natraj Ninjuri, Tracy, CA (US); Ali Djabbari, Saratoga, CA (US); Marko Kalemkeris, Ashland, OR (US); Ramin Katebi, San Jose, CA (US)

(73) Assignee: Wisk Aero LLC, Mountain View, CA (US)

(21) Appl. No.: 19/299,695

(22) Filed: Aug. 14, 2025

Related U.S. Application Data
(60) Provisional application No. 63/683,107, filed on Aug. 14, 2024.

(51) Int. Cl. H02P 6/18; B60L 50/40; B60L 50/51; B60L 50/60; H02P 27/08

(52) U.S. Cl. CPC H02P 6/18; B60L 50/40; B60L 50/51; B60L 50/60; H02P 27/08; B60L 2200/10; B60L 2210/42; B60L 2240/427; B60L 2240/429; H02P 2203/11; H02P 2207/05

(57) ABSTRACT

Embodiments provide a method for propulsion system control. The method includes receiving a first set of electrical parameters associated with a first set of windings of a plurality of windings of the three-phase motor, the first set of electrical parameters separated from a second set of electrical parameters associated with a second set of windings by a phase shift. The method further include determining a first set of control parameters for controlling a first amount of power delivered to the first set of windings. The method further includes determining an angle of a rotor. The method further includes adding the phase shift to the first set of electrical parameters to generate an updated first set of electrical parameters. The method further includes determining a second set of control parameters for controlling a second amount of power delivered to the second set of windings.

### CROSS-REFERENCE TO RELATED APPLICATIONS

This application claims benefit under 35 USC §119(e) to U.S. Provisional Ser. No. 63/683,107 filed Aug. 14, 2024, and entitled “INDEPENDENT SLIDING MODE OBSERVERS FOR FAULT TOLERANT OPERATION OF MULTI-PHASE MACHINES,” the disclosure of which is incorporated by reference herein in its entirety for all purposes.

### FIELD

The described embodiments relate generally to an aircraft. In particular, the embodiments provide an aircraft computing system for communicating with independent sliding mode observers for fault tolerant operation of multi-phase machines.

### BACKGROUND

Pilotless aircraft include propulsion system(s) for powering the aircraft's rotors. Improved propulsion system designs are desired. A conventional electric propulsion system can seek to mitigate a single point of failure by executing two sliding mode observers in a single FPGA and use complex control logics to decide which one should be made active. However, this approach can rely on code that is associated with a high overhead. For example, the code can include extra computations that introduce delay, memory usage, and other system demands. Furthermore, the code may also occupy a large volume of memory.

### SUMMARY

Various embodiments provide an aircraft's propulsion system with techniques for switching control of the propulsion system from a primary control unit (e.g., command board) to a backup control unit (e.g., backup board). The primary control unit can regulate power provided to a multi-phase aircraft motor to rotate the aircraft's rotors. Therefore, if a monitoring unit (e.g., monitor board) determines that there is a failure at the primary control unit, the monitoring unit can switch control from the primary control unit to the backup control unit.

In some embodiments, a command board can receive a first set of electrical parameters associated with a first set of windings of a plurality of windings of the multi-phase motor. The command board can then use the first set of electrical parameters to determine a first set of control parameters for controlling a first amount of power delivered to the three-phase motor, and in particular, the first set of windings.

The command board can then determine an angle of a rotor of the multi-phase motor based on the first set of electrical parameters using an angle estimator. The command board can then add the phase shift to a signal associated with the first set of electrical parameters to determine an updated first set of electrical parameters. The command board can then determine, based on the updated first set of electrical parameters, a second set of control parameters for controlling a second amount of power delivered to the second set of windings.

The above-described operations can be monitored by a monitor board. In the event that the monitor board detects a failure at the command board, the monitor board can switch operations to the backup board, which can be configured to perform operations similar to the command board.

These and other embodiments are described in further detail below.

### BRIEF DESCRIPTION OF THE DRAWINGS

FIG. 1 is an illustration of an example electric propulsion system, according to one or more embodiments.

FIG. 2 is an illustration of an example controller, according to one or more embodiments.

FIG. 3 is an illustration of an example controller, according to one or more embodiments.

FIG. 4 is an illustration of an example controller, according to one or more embodiments.

FIG. 5 is an illustration of an example command board, according to one or more embodiments.

FIG. 6 is an illustration of an example backup board, according to one or more embodiments.

FIG. 7 is an illustration of an example monitor board, according to one or more embodiments.

FIG. 8 is an illustration of an example process for a controller, according to one or more embodiments.

FIG. 9A is an illustration of an exemplary embodiment of the VTOL aircraft with tilting fan assemblies according to one or more embodiments.

FIG. 9B is an illustration of an exemplary embodiment of the VTOL aircraft with tilting fan assemblies according to one or more embodiments.

### DETAILED DESCRIPTION

Techniques disclosed herein relate generally to an aircraft propulsion system that can switch control from a primary controller to a backup controller. More specifically, techniques disclosed describe an aircraft propulsion system that can monitor the primary controller that regulates power to an aircraft motor for failure detection. In the event that a failure is detected, the propulsion system can switch control to a backup controller. Various inventive embodiments are described herein, including methods, processes, systems, devices, and the like.

In order to better appreciate the features and aspects of the aircraft according to the present disclosure, further context for the disclosure is provided in the following section by discussing particular implementations of a VTOL aircraft according to embodiments of the present disclosure. These embodiments are for example only, and other configurations can be employed in connection with the aircraft described herein.

The embodiments herein describe an electric propulsion system, including a motor and a motor controller, for an aircraft. The motor can include a permanent magnet synchronous motor (PMSM) and have two sets of three phase windings, and for fault tolerance each of the sets of three phase windings can be responsible for producing half the torque of the total torque produced by the motor. The three phase windings can be magnetically coupled and set to have electrical parameters for signals (e.g., current signal values, voltage signal values) that are a threshold angle (e.g., at or about a 30-degree phase shift) apart from each other. The electrical paragraphs can include, for example, values for magnitude, frequency, phase, power factor, or other electrical parameters. The two sets of three phase windings can further be controlled using two inverter power stages. Each inverter stage can include a gate driver, semiconductor devices (e.g., metal oxide semiconductor field effect transmitters (MOSFETs), and direct current (DC) link capacitors, where the DC link capacitors can be shared by each inverter. Each inverter can use a set of six MOSFET modules to operate two sets of three phase windings of the electric propulsion system. The electric propulsion system can be controlled by using a controller that includes a command board, a monitor board, and a backup board. Each board can include a respective field programmable gate array (FPGA) for controlling an aspect of the electric propulsion system.

One issue that can occur with an electric propulsion system is a single point of failure at the windings. A conventional electric propulsion system can seek to mitigate a single point of failure by executing two sliding mode observers in a single FPGA and use complex control logics to decide which one should be made active. However, this approach can rely on code that is associated with a high overhead. For example, the code can include extra computations that introduce delay, memory usage, and other system demands. The code may also occupy a large volume of memory.

The embodiments herein address this issue by describing techniques for using the monitor board to monitor a performance of the electric propulsion system. In the instance that the monitor board detects a failure at the command board, the monitor board can cause the controls of the machine to switch from a first FPGA (e.g., command FPGA) at the command board to a second FPGA (e.g., a backup FPGA) at the backup board to avoid the single point failure. The embodiments herein provide a high amount of fault tolerance and reduced controller code complexity. This allows for less code overhead and lower verification efforts for the electric propulsion system.

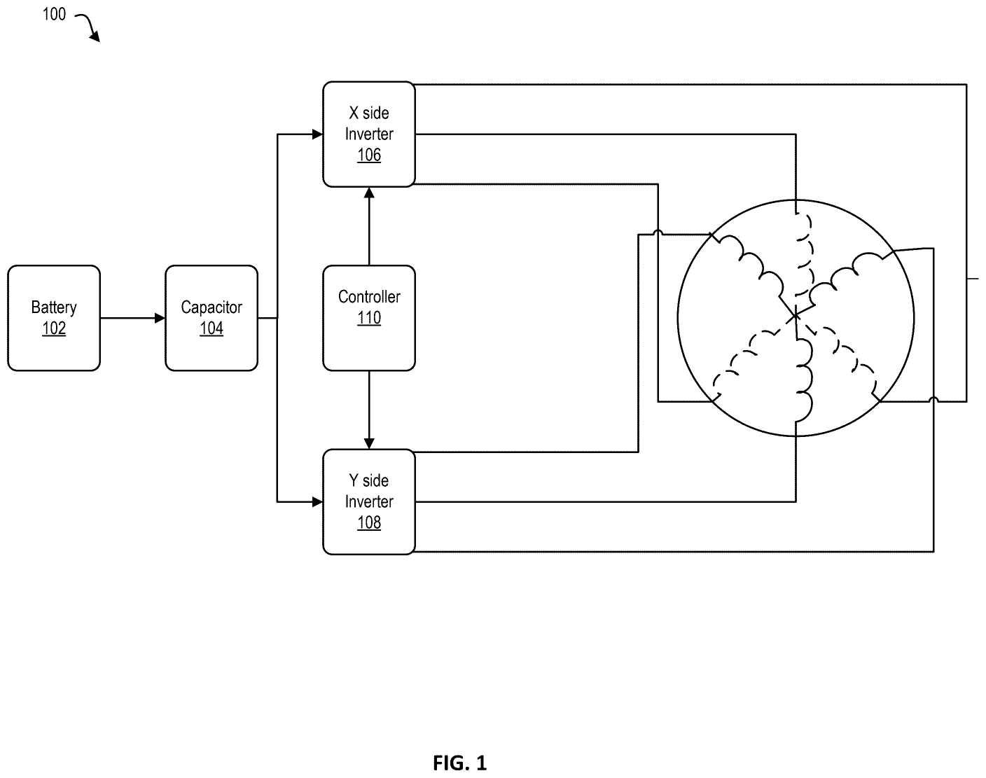

FIG. 1 is an illustration of an example electric propulsion system 100, according to one or more embodiments. The electric propulsion system 100 can include a power source, such as a battery 102 connected to a capacitor 104, where the capacitor 104 can include a capacitor bank. The power source can provide power to an x side inverter 106 and a y side inverter 108. As illustrated, the x side inverter 106 is connected to a first set of three windings and the y side inverter is connected to a second set of three windings. For illustration purposes, the first set of three phase windings has been illustrated with a dashed line and the second set of three phase windings has been illustrated with a solid line.

The electric propulsion system 100 can include a motor for rotating a rotor connected to a propeller of an aircraft. As described herein, the signal associated with the electrical parameters of the first set of three phase windings can be 30 degrees out of phase from signal associated with the electrical parameters of the second set of three phase windings. The power source can provide power to the windings. As the current flows through the windings, a rotating magnetic field can be created. The rotating magnetic field can cause a current to flow through a rotor, which induces a magnetic field at the rotor. The magnetic field at the rotor can interact with the rotating magnetic field at the windings. This interaction between magnetic fields at the rotor and the rotating magnetic field at the winding causes a torque on the rotor and causes the rotor to rotate. The rotor can be in operable communication with an aircraft propeller, which turns based on the rotation of the rotor. For the aircraft to function properly, the rotor needs to rotate at the proper angular velocity. Furthermore, a positioning of the rotor can be based on the electrical parameters of the three-phase motor. Therefore, the controller of the electric propulsion system 100 may continuously collect electrical parameters (e.g., current signal values, voltage signal values) and estimate a position of the rotor with respect to the rotating magnetic field. If the controller's estimate of the position of the rotor is not a desired position, the controller may cause a change in the electrical parameters at either the first set of windings or the second set of windings to either increase or decrease the torque produced on the rotor.

The control techniques described herein can be considered as sensorless techniques, as the techniques do not rely on information from a rotor position sensor. Rather the rotor's position is estimated based on x side inverter parameters and y side inverter parameters. As discussed below, the x side inverter parameters can be used to deliver power to the first set of three phase windings and the y side inverter parameters can be used to deliver power to the second set of three phase windings.

A controller 110 can be configured to control the x side inverter 106 and the y side inverter 108. For example, on a command board of the controller 110, a first FPGA can receive a first set of electrical parameters (e.g., current signal values, voltage signal values) associated with the first set of windings. The electrical parameters can be measured with respect to the x side electrical parameters by the first FPGA at the command controller. At the same time, electrical parameters can be measured by the second FPGA at the backup board with respect to the y side electrical parameters. The first FPGA can process the electrical parameters and determine a first set of control parameters for controlling a first amount of power delivered to the first set of windings. The amount of power can be related to the rotation of a rotor and the rotor can be connected to the propeller of an aircraft.

The first FPGA can determine an angle of the rotor of the three-phase motor based on the first set of electrical parameters using an angle estimator. For example, the first FPGA can be configured with a reference angle and determine the angle of the rotor with respect to the reference angle. The first FPGA can determine a phase shift (e.g., 30-degree phase shift) to be added to a first signal associated with the first set of electrical parameters to generate an updated set of electrical parameters corresponding to the y side. For example, the first FPGA can determine the updated set of electrical parameters associated with a second signal, where the second signal is determined based on adding the phase shift to the first signal. The first FPGA can then determine, based on the updated set of electrical parameters, a second set of control parameters for controlling a second amount of power delivered to the second set of windings. The second amount of power can be to cause the rotation of the rotor to be at a desired rotation. For example, the desired rotation can include a desired rotational speed to move in particular direction and a particular speed (e.g., ascend, descend, forward, backward, side motion, or other appropriate direction and speed).

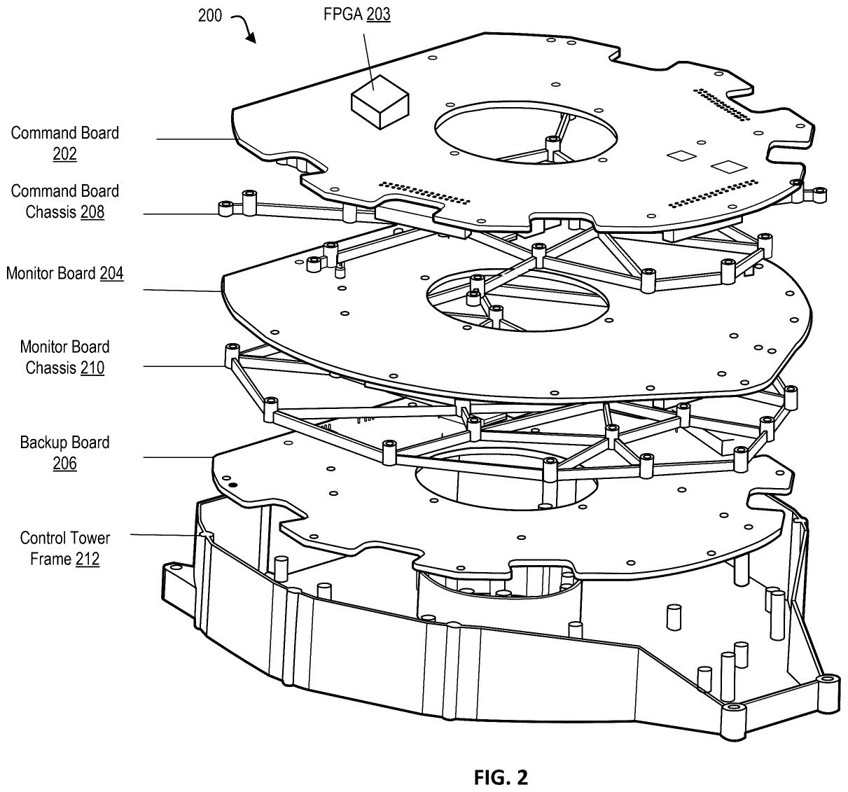

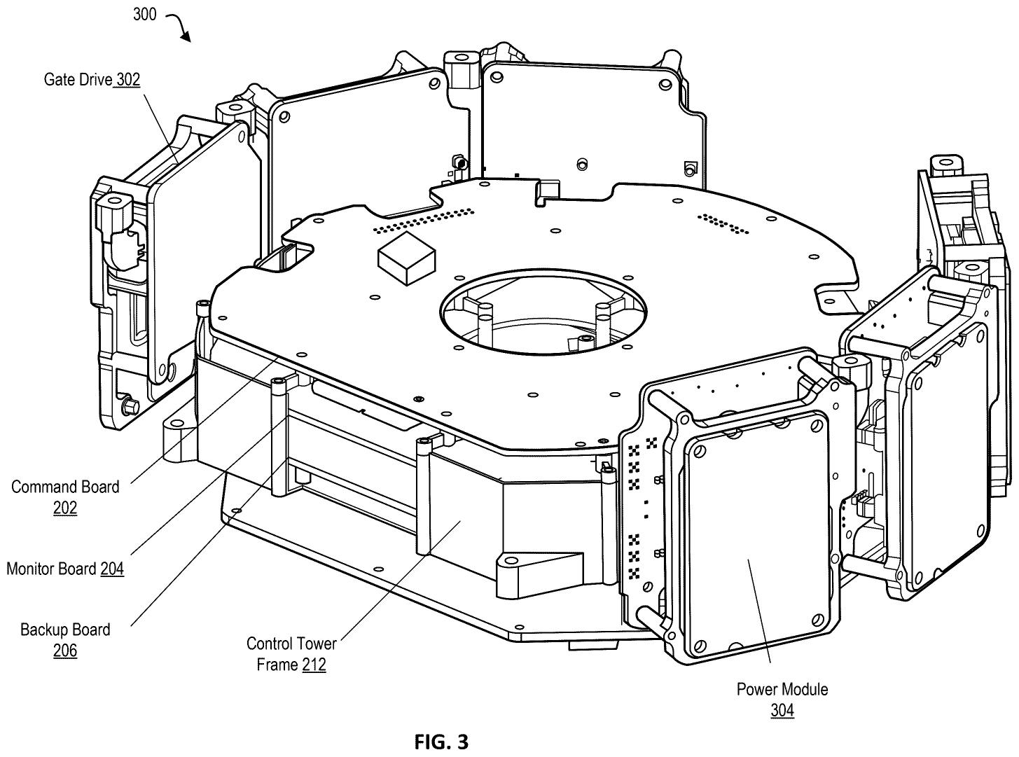

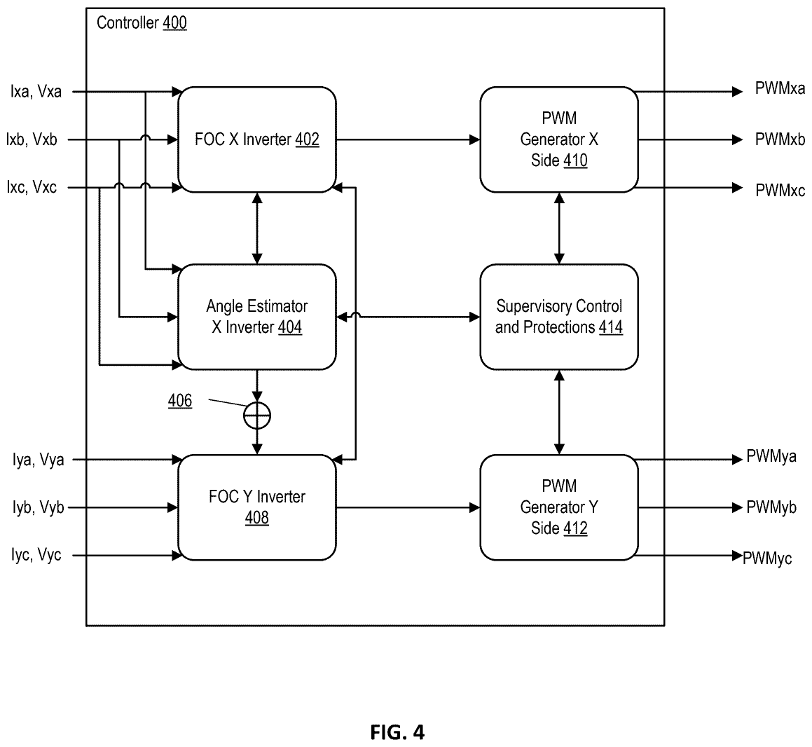

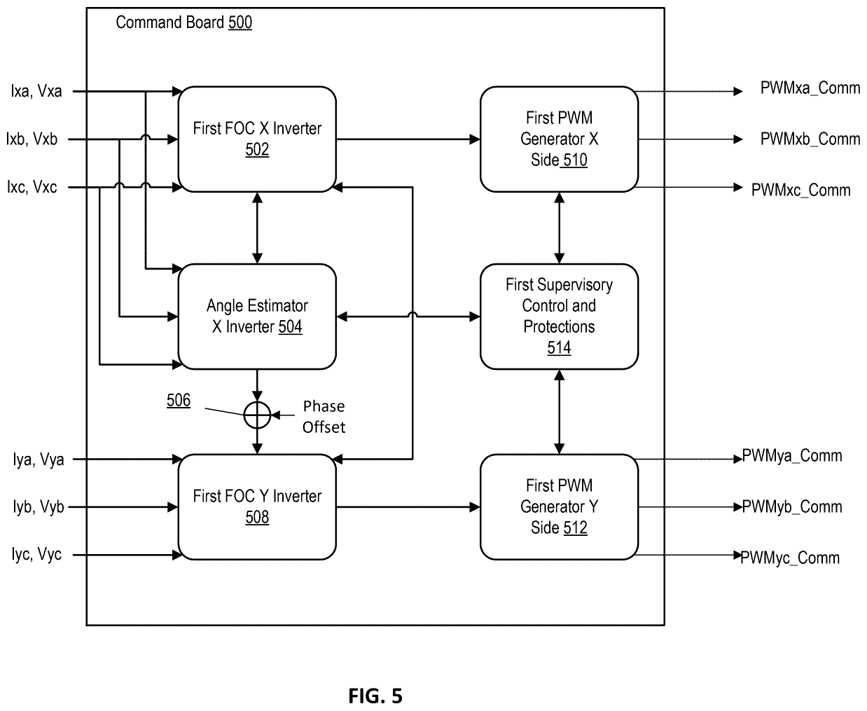

FIGS. 3 and 4 are illustrations of an example controller (e.g., controller 110) that includes a command board, a monitor board, and a backup board. It should be appreciated that although not illustrated, each of the boards can include various electrical components (e.g., resistors, capacitors, inductors, and other electrical components). FIG. 2 is an illustration of an example controller 200, according to one or more embodiments. The controller 200 can include a command board 202, a monitor board 204, and a backup board 206. The command board 202 can have a first FPGA 203 that is configured to collect electrical parameter measurements of the first set of windings (e.g., x side windings) and of the second set of windings (e.g., y side windings). The command board 200 can process the electrical parameters and determine a set of control parameters for controlling a first amount of power delivered to the windings of the three-phase motor of the electric propulsion system (e.g., electric propulsion system 100). The command board 202 can determine an angle of the rotor of the three-phase motor based on the electrical parameters using an angle estimator. The command board 202 can determine a phase shift to be added to signal associated with the electrical parameters to determine an updated signal and updated electrical parameters based on the updated signal. The updated electrical parameters can correspond to the y side. The command board 202, based on the updated electrical parameters, can determine a set of control parameters for controlling an amount of power delivered to the three-phase motor. A command board is described in more detail with respect to FIG. 5.

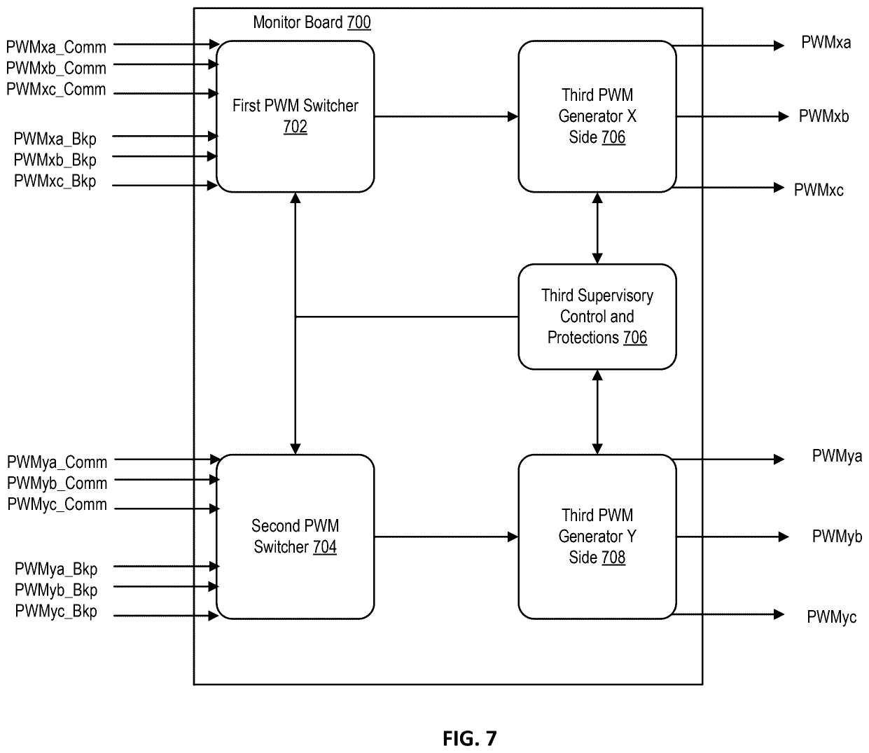

The monitor board 204 can be configured to monitor the command board 202. At a point in time, the monitor board 210 may detect a failure (e.g., failure to output control parameters, outputting control parameters outside of a threshold range of control parameters, outputting incomplete control parameters, or other failure). For example, as the aircraft is in flight, the monitor board 204 can detect that there is a failure at the command board 202. In these instances, the monitor board 204 can cause the control of the electric propulsion system to switch from the command board 202 to the backup board 206. A monitor board 204 is described with more detail with respect to FIG. 7.

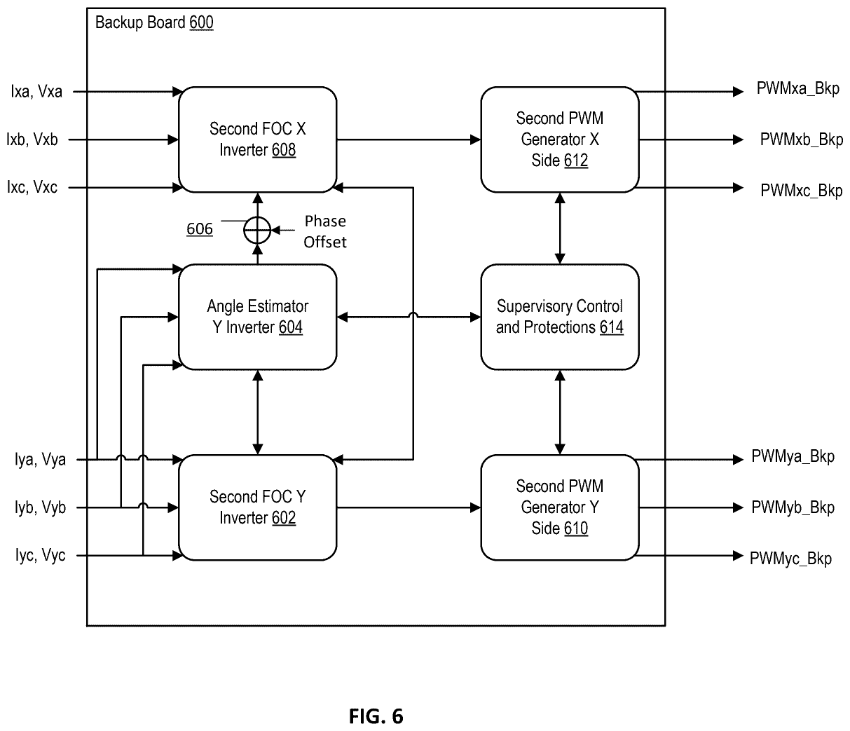

The backup board 206 can include a second FPGA that is configured to determine electrical parameters simultaneously to the command board 202. The backup board 206 can also have a second FPGA that is configured to determine electrical parameter measurements of the first set of windings (e.g., x side windings) and of the second set of windings (e.g., y side windings). The backup board 206 can process the electrical parameters and determine a set of control parameters for controlling a first amount of power delivered to the three-phase motor of the electric propulsion system. The backup board 206 can determine an angle of the rotor of the three-phase motor based on the electrical parameters using an angle estimator. The backup board 206 can determine a phase shift to be subtracted from a first signal associated with electrical parameters to generate updated electrical parameters corresponding to the y side. For example, the second FPGA can determine the updated set of electrical parameters associated with a second signal, where the second signal is determined based on subtracting the phase shift from the first signal. The backup board 206, based on the updated electrical parameters, can determine a set of control parameters for controlling the amount of power delivered to the windings of the three-phase motor. Although the backup board can perform the same computations as the command board 202, until the monitor board causes a switch to the backup board 206, the command board controls the electrical propulsion system. However, by performing the computations simultaneously to the command board 202, the backup board 206 can seamlessly assume control of the electric propulsion system in the event the monitor board 204 switches control from the command board 202 to the backup board 206. A backup board is described in more detail with respect to FIG. 6. The controller 200 can further include a command board chassis 208 and a monitor board chassis 210 for securing the command board 202 and the monitor board 204 to a control tower frame 212.

FIG. 3 is an illustration of an example controller 300, according to one or more embodiments. The controller 300 (e.g., controller 200) can be part of an electric propulsion system and include a command board 202, a monitor board 204, a backup board 206, and a control tower frame 212. As illustrated, the command board 202, the monitor board 204, and the backup board 206 are arranged in a compartment formed by the control tower frame 212. The monitor board 204 and the backup board 206 can further be secured to the control tower frame 212 via respective chassis (e.g., command board chassis 208 and a monitor board chassis 210).

The controller 300 can include a gate drive 302 used to control the inverters (e.g., x side inverter 106, a y side inverter 108) of an electric propulsion system (e.g., electric propulsion system 100). The inverters can include semiconductor devices and the gate drive 302 can provide voltage and current to control the transistors of the semiconductor devices on and off. The controller 300 can further include a power module 304, such as one or more batteries connected to a set of capacitors. The power module 304 can provide power to the electric propulsion system.

FIG. 4 is an illustration of an example controller 400, according to one or more embodiments. The controller 400 can be configured to operate an electric propulsion system of an aircraft (e.g., a vertical takeoff and landing (VTOL) aircraft). A field-oriented controller (FOC) x inverter 402 can receive a direct current (DC) from a power source (e.g., battery 102, capacitor 104) and convert the DC power to an alternating current (AC) that is delivered to the windings. As illustrated, the FOC x inverter 402 can receive a first signal associated with current and voltage parameters (e.g., Ixa, Vxa) for a first winding, a second signal associated with current and voltage parameters (e.g., Ixb, Vxb) for a second winding, and a third signal associated with current and voltage parameters (e.g., Ixc, Vxc) for a third winding.

The angle estimator x inverter 404 can further transmit the first signal to an adder 406. The adder 406 can add a phase shift (e.g., a thirty-degree phase shift) to the first signal to generate an updated first signal. The updated first signal can be associated with updated electrical parameters. The updated first signal can be transmitted to an FOC y inverter 408.

As illustrated, the FOC y inverter 408 can receive a fourth signal associated with current and voltage parameters (e.g., Iya, Vya) for a fourth winding, a fifth signal associated with current and voltage parameters (e.g., Iyb, Vyb) for a fifth winding, and a sixth signal associated with current and voltage parameters (e.g., Iyc, Vyc) for a sixth winding.

The FOC x inverter 402 can transmit an output to a pulse width modulator (PWM) generator x side 410 for supplying power to the first set of windings (e.g., x side windings). The PWM generator x side 410 can control the power transfer from the FOC x inverter 402 to the first set of windings by quickly switching between power modes. For example, the PWM generator x side 410 can switch between a full power mode and a no power mode. As illustrated, the PWM generator x side 410 can transmit power to a first winding (e.g., PWMxa), a second winding (e.g., PWMxb), and a third winding (e.g., PWMxc).

The FOC y inverter 408 can transmit an output to a PWM generator y side 412 for supplying power to the second set of windings (e.g., y side windings). The PWM generator y side 412 can control the power transfer from the FOC y inverter 408 to the second set of windings by quickly switching between power modes. As illustrated, the PWM generator y side 412 can transmit power to a fourth winding (e.g., PWMya), a fifth winding (e.g., PWMyb), and a sixth winding (e.g., PWMyc).

A supervisory control and protections unit 414 can be associated with a controller (e.g., controller 110) and communicate with the angle estimator x inverter 404, the PWM generator x side 410, and the PWM generator y side 412. The supervisory control and protections unit 414 can communicate with each of the PWM generator x side 410 the PWM generator y side 412 either increase the power delivered to the windings, decrease the power delivered to the windings, or maintain the level of power delivered to the windings based on an estimate of the rotor angle. In this sense, an aircraft's propeller can continuously receive an optimal level of power while in flight.

FIGS. 5, 6, and 7 are illustrations of a command board, a backup board, and a monitor board of a controller for an electric propulsion system. As described below, the command board and the backup board perform similar computations. However, the monitor board decides which of the command board and the backboard controls the power delivered to the windings.

FIG. 5 is an illustration of an example command board, according to one or more embodiments. The command board 500 (e.g., command board 202) can be configured to determine an electrical parameter output for a first set of windings and a second set of windings of an electric propulsion system of an aircraft. The outputs from the command board 500 are used to power the electric propulsion system unless the monitor board switches from the command board 500 to a backup board. As illustrated, the first FOC x inverter 502 can receive a fist signal associated with current and voltage parameters (e.g., Ixa, Vxa) for a first winding, a second signal associated with current and voltage parameters (e.g., Ixb, Vxb) for a second winding, and a third signal associated with a current and voltage parameters (e.g., Ixc, Vxc) for a third winding.

The angle estimator x inverter 504 can further transmit the first signal, the second signal, and the third signal to a first adder 506. The first adder 506 can add a phase shift (e.g., a thirty-degree phase shift) to a first signal associated with the electrical parameters determined from the first set of windings to determine an updated first signal. The first updated signal can be associated with updated electrical parameters. The updated first signal can be transmitted to a first FOC y inverter 508.

As illustrated, the first FOC y inverter 508 can receive a fourth signal associated with current and voltage parameters (e.g., Iya, Vya) for a fourth winding, a fifth signal associated with current and voltage parameters (e.g., Iyb, Vyb) for a fifth winding, and a sixth signal associated with current and voltage parameters (e.g., Iyc, Vyc) for a sixth winding.

The first FOC x inverter 502 can transmit an output to a first PWM generator x side 510 for supplying power to the first set of windings. The first PWM generator x side 510 can control the power transfer from the first FOC x inverter 502 to the first set of windings. As illustrated, the first PWM generator x side 510 can transmit an output associated with first winding (e.g., PWMxa_Comm), a second winding (e.g., PWMxb_Comm), and a third winding (e.g., PWMxc_Comm) to a first PWM switch of a monitor board (see, FIG. 7).

The first FOC y inverter 508 can transmit an output to a first PWM generator y side 512 for supplying power to the second set of windings. The first PWM generator y side 512 can control the power transfer from the first FOC y inverter 508 to the second set of windings by quickly switching between power modes. As illustrated, the first PWM generator x side 510 can transmit an output associated with a fourth winding (e.g., PWMya), a fifth winding (e.g., PWMyb), and a sixth winding (e.g., PWMyc) to a second PWM switcher (see, FIG. 7).

A first supervisory control and protections unit 514 can be associated with a controller and communicate with the angle estimator x inverter 504, the first PWM generator x side 510, and the first PWM generator y side 512. The first supervisory control and protections unit 514 can communicate with each of the first PWM generator x side 510 the first PWM generator y side 512 either increase the power delivered to the windings, decrease the power delivered to the windings, or maintain the level of power delivered to the windings based on an estimate of the rotor angle. In this sense, an aircraft's propeller can continuously receive an optimal level of power while in flight.

FIG. 6 is an illustration of an example backup board, according to one or more embodiments. The backup board 600 (e.g., backup board 206) can be configured to determine electrical parameters of an output for a first set of windings and a second set of windings of an electric propulsion system for an aircraft. The outputs from the backup board 600 are not used to power the electric propulsion system unless the monitor board switches from a command board to the backup board 600. As illustrated, the second FOC y inverter 602 can receive a fourth signal associated with current and voltage parameters (e.g., Iya, Vya) for a fourth winding, a fifth signal associated with current and voltage parameters (e.g., Iyb, Vyb) for a fifth winding, and a sixth signal associated with current and voltage parameters (e.g., Iyc, Vyc) for a sixth winding.

The angle estimator y inverter 604 can further transmit the electrical parameters to a second adder 606. The second adder 506 can perform a subtraction operation (e.g., add a negative number to a positive number) to subtract a phase shift (e.g., at or about thirty-degree phase shift) from signals associated with the electrical parameters determined from the second set of windings. As used herein, at or about can include a number of degrees within a range of twenty-five degrees to thirty-five degrees. The updated signals can be associated with updated electrical parameters that can be transmitted to a second FOC x inverter 608.

As illustrated, the second FOC y inverter 608 can receive a first signal associated with current and voltage parameters (e.g., Ixa, Vxa) for a first winding, a second signal associated with current and voltage parameters (e.g., Ixb, Vxb) for a second winding, and a third signal associated with current and voltage parameters (e.g., Ixc, Vxc) for a third winding.

The second FOC y inverter 602 can transmit an output to a second PWM generator y side 610 for supplying power to the second set of windings. The second PWM generator y side 610 can control the power transfer from the second FOC y inverter 602 to the second set of windings. As illustrated, the second PWM generator y side 610 can further transmit an output associated with a fourth winding (e.g., PWMya_Bkp), a fifth winding (e.g., PWMyb_Bkp), and a sixth winding (e.g., PWMyc_Bkp) to a second PWM switcher of a monitor board.

The second FOC x inverter 608 can transmit an output to a second PWM generator x side 612 for supplying power to the first set of windings. The first PWM generator y side 612 can control the power transfer from the first FOC y inverter 608 to the first set of windings by quickly switching between power modes. As illustrated, the second PWM generator x side 612 can transmit an output associated with a first winding (e.g., PWMxa_Bkp), a second winding (e.g., PWMxb_Bkp), and a third winding (e.g., PWMxc_Bkp) to a first PWM switcher of a monitor board.

A second supervisory control and protections unit 614 can be associated with a controller and communicate with the angle estimator y inverter 604, the second PWM generator y side 610, and the second PWM generator x side 612. The second supervisory control and protections unit 614 can communicate with each of the second PWM generator y side 610 and the second PWM generator x side 612 to either increase the power delivered to the windings, decrease the power delivered to the windings, or maintain the level of power delivered to the windings based on an estimate of the rotor angle.

It is illustrated that in the command board 500, the primary inverter is the first FOC x inverter 510. It is further illustrated that in the backup board 600, the primary inverter is the second FOC y inverter 610. Therefore, if the monitor board switches from the command board 500 to the backup board 600, the primary inverter also switches from an x side to a y side. This is another safety feature of the herein described electric propulsion system. For example, if the monitor board detects a fault at the command board 500 and that fault is related to the x side, then switching to the backup board 600 can also mitigate an issue at the x side.

FIG. 7 is an illustration of an example monitor board, according to one or more embodiments. The monitor board 700 can monitor the operation of the command board (e.g., command board 500). If the monitor board 700 determines that a failure in the operation of the command board, it can switch operation from the command board to a backup board (e.g., backup board 600). A first PWM switcher can receive on input from a first PWM generator x side (e.g., first PWM generator x side 510) and a second PWM generator x side (e.g., second PWM generator x side 612). A second PWM switcher 704 can receive an input from a second PWM generator y side (e.g., second PWM generator y side 512) and a first PWM generator y side (e.g., first PWM generator y side 610).

Each of the first PWM switcher 702 and the second PWM switcher 704 can communicate with a third supervisory control and protections 706 for switching from the command board to the backup board. As indicated above, the third supervisory control and protections 706 can monitor the command board and if a failure is determined, the third supervisory control and protections 706 can cause control to switch from the command board to the backup board using the first PWM switcher 702 and the second PWM switcher 704.

The first PWM switcher 702 can transmit an output to the third PWM generator x side 706. As illustrated, the third PWM generator x side 706 can transmit an output associated with a first winding (e.g., PWMxa), a second winding (e.g., PWMxb), and a third winding (e.g., PWMxc). The second PWM switcher 704 can transmit an output to the third PWM generator y side 708. As illustrated, the third PWM generator y side 708 can transmit an output associated with a fourth winding (e.g., PWMya), a fifth winding (e.g., PWMyb), and a sixth winding (e.g., PWMyc).

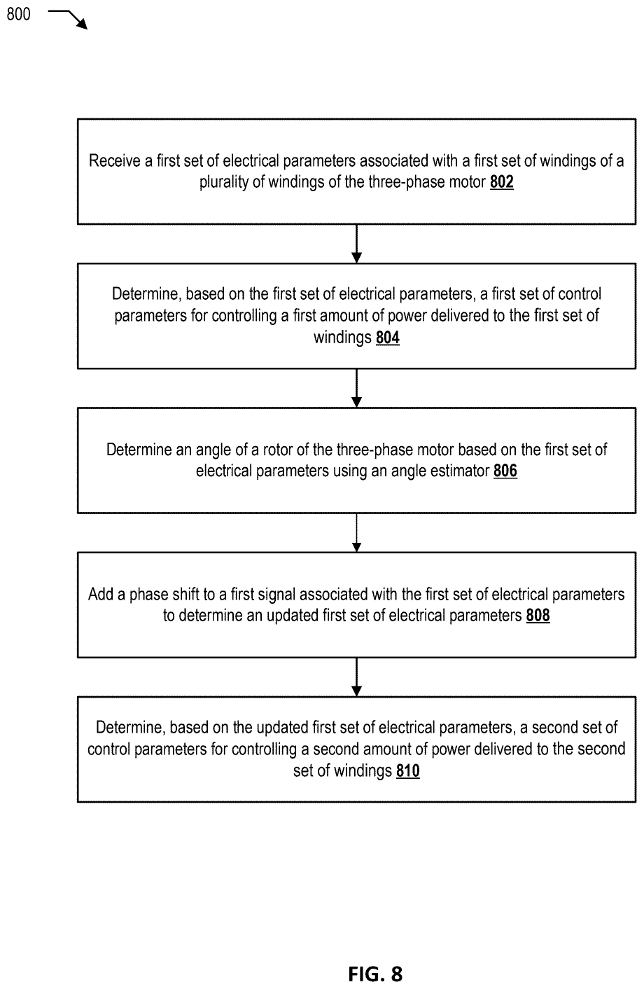

FIG. 8 is an illustration of an example process 800 for a controller, according to one or more embodiments. The controller (e.g., controller 110, controller 400) can be, for example, a field programmable gate array (FPGA). At 802, the process 802 can include the control, on a command board (e.g., command board 500) of the controller, receiving a first set of electrical parameters associated with a first set of windings of a plurality of windings of the three-phase motor. The signal associated with the first set of electrical parameters can be distinct from a second set of electrical parameters associated with signal associated with a second set of windings based on a phase shift between them. In some embodiments, the first set of electrical parameters can include three current values, each current value associated with a respective winding of the first set of windings. In other embodiments, the first set of electrical parameters can include three voltage values, each voltage value associated with a respective winding of the first set of windings. The phase shift can be, for example, at or about 30-degree phase shift, or other phase shift. The plurality of windings can include, for example, six windings or other number of windings.

The three-phase motor can be, for example, powered by a battery (e.g., battery 102,) connected to a capacitor (capacitor 104). The three-phase motor can be, for example, be used for a vertical take-off and landing (VTOL) aircraft (e.g., VTOL aircraft 902). In some embodiments, the three-phase motor can include a permanent magnet synchronous motor (PMSM). The process 800 can include aligning a current vector with a rotor magnetic field to optimize a torque of the three-phase motor.

At 804, the process 800 can include the command board determining, based on the first set of electrical parameters, a first set of control parameters for controlling a first amount of power delivered to the first set of windings.

At 806, the process 800 can include the command board determining an angle of a rotor of the three-phase motor based on the first set of electrical parameters using an angle estimator.

At 808, the process 800 can include the command board adding the phase shift to the first set of electrical parameters to generate an updated first set of electrical parameters.

At 810, the process can include the command board determining, based on the updated first set of electrical parameters, a second set of control parameters for controlling a second amount of power delivered to the second set of windings.

On the backup board of the controller, the process 800 can include collecting a second set of electrical parameters associated with the second set of windings of the plurality of windings of the three-phase motor. The process 800 can further include determining, based on the second set of electrical parameters, a first set of backup control parameters for controlling a first amount of power delivered to the first set of windings. The process can further include determining a backup angle of the rotor of the three-phase motor based on the second set of electrical parameters using an angle estimator. The process can further include adding the phase shift to a signal associated with the second set of electrical parameters to generate an updated second set of electrical parameters. The process can further include determining, based on the updated second set of electrical parameters, a second set of backup control parameters for controlling a second amount of power delivered to the first set of windings.

As indicated above, the process 800 can include controlling an amount of power delivered to the first set of windings using the command board. The process 800 can further include identifying a failure associated with the command board. The process 800 can further include controlling the amount of power delivered to the first set of windings using the backup board based on identifying the failure.

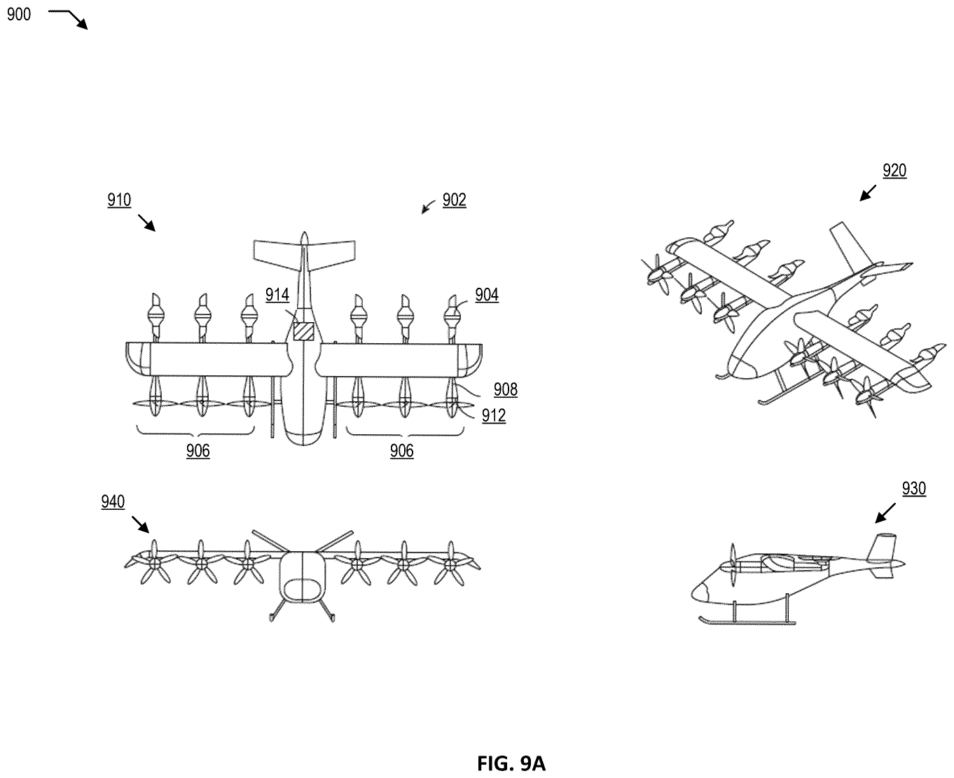

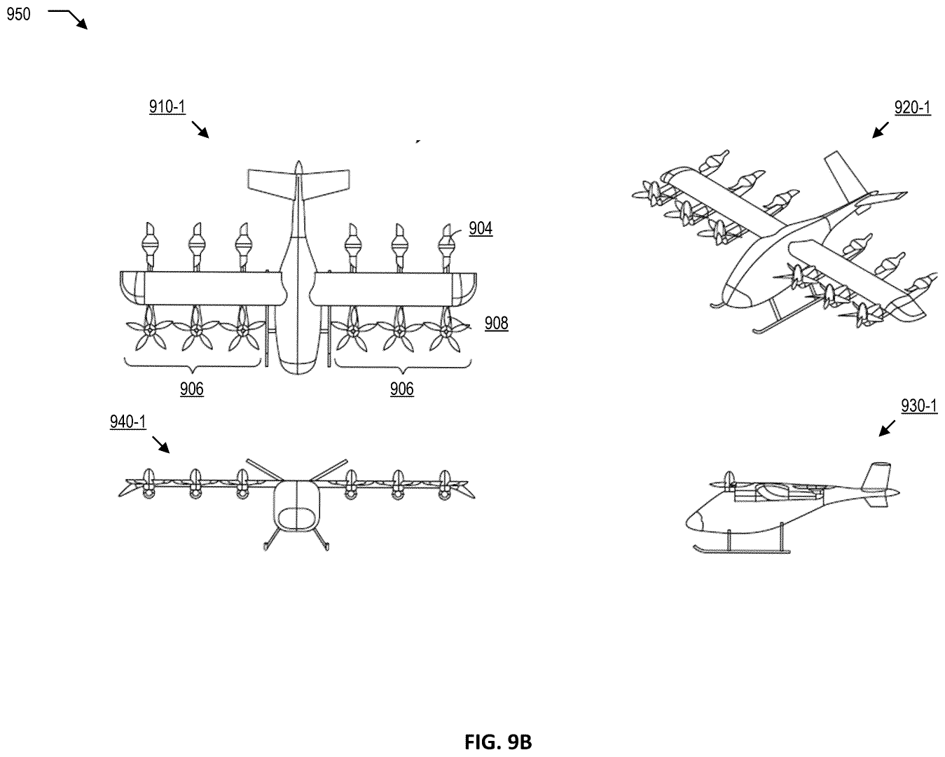

FIGS. 9A and 9B illustrate another exemplary embodiment of the VTOL aircraft with tilting fan assemblies. It should be appreciated that although FIGS. 9A and 9B describe a VTOL aircraft, the embodiments herein can be used for various other types of aircraft (e.g., a fixed wing aircraft, rotary-wing aircraft) FIG. 9A is an illustration 900 of an exemplary embodiment of the VTOL aircraft with tilting fan assemblies 904 according to one or more embodiments. FIG. 9B is an illustration 950 of an exemplary embodiment of the VTOL aircraft with tilting fan assemblies 904 according to one or more embodiments. In the example embodiment illustrated in FIGS. 9A and 9B, a plurality of lift fan assemblies 904 are provided at a tailing edge of the pair of wings and a plurality of tilting fan assemblies are provided at a leading edge of the pair of wings. The example VTOL aircraft 902 illustrated in FIGS. 9A and 9B includes all front fan assemblies configured as tilting fan assemblies 906. Thus, in the example VTOL aircraft 902, all booms 908 are identical and each includes a tilting fan assembly 906 on one end and a lift fan assembly 904 on the opposite end. Since all booms 908 are identical, the booms 908 may be interchangeable between the positions on the wings. For example, the first boom closer to the fuselage may be interchangeable with the adjacent second boom (e.g., the middle boom on the wing) or the third boom further away from the fuselage. In some embodiments, each tilting fan assembly 906 may be coupled to the boom 908 via an individual tilting mechanism. For example, at least three tilting fan assemblies may be coupled to each pair of wings, as shown in FIG. 9A.

FIG. 9A illustrates top 910, planar 920, side 930, and front 940 views (clockwise starting from the top left corner) of the VTOL aircraft 902 with front tilting fan assemblies 906 in the forward flight position. FIG. 9B illustrates top 910-1, planar 920-1, side 930-1, and front 940-1 views (clockwise starting from the top left corner) of the VTOL aircraft 902 with front tilting fan assemblies 906 in the vertical lift position (e.g., front tilting fan assemblies 906 facing upward toward the sky).

The control system 914 (e.g., aircraft computing system) coupled to the aircraft 902 may be configured to control the tilting mechanisms to switch the positioning of the tilting fan assemblies 906 from the forward flight position (illustrated in FIG. 9A) to the vertical lift position (illustrated in FIG. 9B); as well as from the vertical lift position (illustrated in FIG. 9B) to the forward flight position (illustrated in FIG. 9A). According to various embodiments, the control system 914 may control the tilting fan assemblies 907 between the two positions based on sensor data and/or flight data received from the sensors (e.g., sensor measuring air temperature, electric motor temperature, airspeed of the aircraft, etc.), computers, and other input/output devices coupled to the aircraft.

The tilting fan assemblies 906 may be coupled to the wings via one or more tilting mechanisms, and the tilting fan assemblies 906 may be controlled individually via the tilting mechanisms. The flight control system 914 may be configured to control the tilting mechanisms simultaneously so as to position all tilting fan assemblies 906 in a same position at the same time. Alternatively, the flight control system may be configured to control the tilting mechanisms 910 independently from each other. This way, the flight control system may identify one or more tilting fan assemblies 906 and control the identified tilting fan assemblies 906 independently from the rest of the tilting fan assemblies. According to various embodiments, the flight control system may use symmetric and/or asymmetric tilting to augment control during hovering and transition (e.g., transition between vertical lift and forward flight). The additional degree of freedom of tilting may augment control during motor out and nominal conditions.

While FIGS. 9A-9B illustrates the tilting fan assemblies 906 on the front (e.g., leading) edge of the wings and the lift fan assemblies 904 on the aft (e.g., tailing) edge of the wings, this configuration is for illustrative purposes and should not be construed as limiting. In some embodiments, the lift fan assemblies 904 may be provided on the leading edge of the wings and the tilting fan assemblies 904 on the tailing edge of the wings.

Yet in other embodiments, the tilting fan assemblies 906 and the lift fan assemblies 904 may be alternated on each one of the front and rear portions of the wings. For example, the leading edge of the first wing may include a first tilting fan assembly 906, a lift fan assembly 904 and a second tilting fan assembly 906. The leading edge of the second wing may include a tilting fan assembly 906, a lift fan assembly 904 and another tilting fan assembly 906. Alternatively, the leading edge of the second wing may include a first lift fan assembly 904, a tilting fan assembly 906, and a second lift fan assembly 904. Similar configurations may be applied to the tailing edge of the first and second wings as well.

In various embodiments, a control system such as the flight control system of the aircraft may be configured to control the actuators (rotors, aerodynamic control surfaces, the tilting fan assemblies, the lift fan assemblies) to cause the aircraft to transition between a vertical lift (e.g., liftoff/hovering/landing) mode and a forward flight mode. For example, the control system may be configured to receive a flight instruction, such as a liftoff instruction, a hovering instruction, a landing instruction or a forward flight instruction. If the flight instruction is a take-off instruction or a landing instruction, the control system may control the one or more of the plurality of tilting fan assemblies that are in the forward flight position to the vertical lift position. If the flight instruction is a forward flight instruction, the control system may control the one or more of the plurality of tilting fan assemblies that are in the vertical lift position to the forward flight tilt position. The control system may then determine a position of a plurality of tilting fan assemblies coupled to the aircraft and control one or more of the plurality of tilting fan assemblies between a vertical lift position and a forward flight position based on the flight instruction. The control system may continuously monitor the position of the plurality of tilting fan assemblies in view of the flight instruction.

### EXAMPLES

In the following sections, further example embodiments are provided.
Example 1 can include a method performed by a controller for a three-phase motor, the method comprising: on a command board of the controller: receiving a first set of electrical parameters associated with a first set of windings of a plurality of windings of the three-phase motor; determining, based on the first set of electrical parameters, a first set of control parameters for controlling a first amount of power delivered to the first set of windings; determining an angle of a rotor of the three-phase motor based on the first set of electrical parameters using an angle estimator; adding a phase shift to a first signal associated with the first set of electrical parameters to generate an updated first set of electrical parameters; and determining, based on the updated first set of electrical parameters, a second set of control parameters for controlling a second amount of power delivered to the second set of windings.
Example 2 can include the method of example 1, wherein the method further comprises: on a backup board of the controller: collecting a second set of electrical parameters associated with the second set of windings of the plurality of windings of the three-phase motor; determining, based on the second set of electrical parameters, a first set of backup control parameters for controlling a first amount of power delivered to the first set of windings; determining a backup angle of the rotor of the three-phase motor based on the second set of electrical parameters using an angle estimator; adding a phase shift to a second signal associated with the second set of electrical parameters to determine an updated second set of electrical parameters; and determining, based on the updated second set of electrical parameters, a second set of backup control parameters for controlling a second amount of power delivered to the first set of windings.
Example 3 can include the method of example 2, wherein the method further comprises: controlling an amount of power delivered to the first set of windings using the command board; identifying a failure associated with the command board; and controlling the amount of power delivered to the first set of windings using the backup board based on identifying the failure.
Example 4 can include the method of any of examples 1-3, wherein the first set of electrical parameters comprises three currents, each current associated with a respective winding of the first set of windings.
Example 5 can include the method of any of examples 1-3, wherein the first set of electrical parameters comprises three voltages, each voltage associated with a respective winding of the first set of windings.
Example 6 can include the method of any of examples 1-5, wherein the phase shift is about a thirty-degree phase shift.
Example 7 can include the method of any of examples 1-6, wherein the method further comprises aligning a current vector with a rotor magnetic field to optimize a torque of the three-phase motor.
Example 8 can include the method of any of examples 1-7, wherein the plurality of windings comprises six windings.
Example 9 can include the method of any of examples 1-8, wherein the controller is a field programmable gate array (FPGA).
Example 10 can include the method of any of examples 1-9, wherein the three-phase motor is powered by a battery connected to a capacitor.
Example 11 can include the method of any of examples 1-10, wherein the three-phase motor is associated with a vertical take-off and landing (VTOL) aircraft.
Example 12 can include the method of any of examples 1-11, wherein the three-phase motor comprises: a permanent magnet synchronous motor (PMSM).
Example 13 can include a controller for a three-phase motor, wherein the controller is configured to perform any of the steps of examples 1-12.
Example 14 can include one or more non-transitory, computer readable media, having stored thereon instructions that, when executed, cause one or more processors to perform any of the steps of examples 1-12.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

For simplicity, various active and passive circuitry components are not shown in the figures. In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Electronic components of the described embodiments may be specially constructed for the required purposes, or may comprise one or more general-purpose computers selectively activated or reconfigured by a computer program stored in the computer. Such a computer program may be stored in a computer readable storage medium, such as, but is not limited to, any type of disk including floppy disks, optical disks, DVDs, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus.

Additionally, spatially relative terms, such as “front or “back” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “front” surface can then be oriented “back” from other elements or features. The device can be otherwise oriented (e.g., rotated 90 degrees or at other orientations) and the spatially relative descriptors used herein interpreted accordingly.

What is claimed is:

1. A method performed by a controller for a three-phase motor, the method comprising:
on a command board of the controller:
receiving a first set of electrical parameters associated with a first set of windings of a plurality of windings of the three-phase motor;
determining, based on the first set of electrical parameters, a first set of control parameters for controlling a first amount of power delivered to the first set of windings;
determining an angle of a rotor of the three-phase motor based on the first set of electrical parameters using an angle estimator;
adding a phase shift to a first signal associated with the first set of electrical parameters to determine an updated first set of electrical parameters; and
determining, based on the updated first set of electrical parameters, a second set of control parameters for controlling a second amount of power delivered to a second set of windings.

2. The method of claim 1, wherein the method further comprises:
on a backup board of the controller:
determining a second set of electrical parameters associated with the second set of windings of the plurality of windings of the three-phase motor;
determining, based on the second set of electrical parameters, a first set of backup control parameters for controlling a first amount of power delivered to the first set of windings;
determining a backup angle of the rotor of the three-phase motor based on the second set of electrical parameters using an angle estimator;
adding a phase shift to a second signal associated with the second set of electrical parameters to determine an updated second set of electrical parameters; and
determining, based on the updated second set of electrical parameters, a second set of backup control parameters for controlling a second amount of power delivered to the first set of windings.

3. The method of claim 2, wherein the method further comprises:
controlling an amount of power delivered to the first set of windings using the command board;
identifying a failure associated with the command board; and
controlling the amount of power delivered to the first set of windings using the backup board based on identifying the failure.

4. The method of claim 1, wherein the first set of electrical parameters comprises three current values, each current value associated with a respective winding of the first set of windings.

5. The method of claim 1, wherein the first set of electrical parameters comprises three voltage values, each voltage value associated with a respective winding of the first set of windings.

6. The method of claim 1, wherein the phase shift is about a thirty-degree phase shift.

7. The method of claim 1, wherein the method further comprises aligning a current vector with a rotor magnetic field to optimize a torque of the three-phase motor.

8. The method of claim 1, wherein the plurality of windings comprises six windings.

9. The method of claim 1, wherein the controller is a field programmable gate array (FPGA).

10. The method of claim 1, wherein the three-phase motor is powered by a battery connected to a capacitor.

11. The method of claim 1, wherein the three-phase motor is associated with a vertical take-off and landing (VTOL) aircraft.

12. The method of claim 1, wherein the three-phase motor comprises:
a permanent magnet synchronous motor (PMSM).

13. A controller for a three-phase motor, the controller comprising:
a command board of the controller, the command board configured to:
receive a first set of electrical parameters associated with a first set of windings of a plurality of windings of the three-phase motor;
determine, based on the first set of electrical parameters, a first set of control parameters for controlling a first amount of power delivered to the first set of windings;
determine an angle of a rotor of the three-phase motor based on the first set of electrical parameters using an angle estimator;
add a phase shift to a first signal associated with the first set of electrical parameters to determine an updated first set of electrical parameters; and
determine, based on the updated first set of electrical parameters, a second set of control parameters for controlling a second amount of power delivered to a second set of windings.

14. The controller for the three-phase motor of claim 13, wherein the controller further comprises:
a backup board of the controller, the backup board configured to:
determine a second set of electrical parameters associated with the second set of windings of the plurality of windings of the three-phase motor;
determine, based on the second set of electrical parameters, a first set of backup control parameters for controlling a first amount of power delivered to the first set of windings;
determine a backup angle of the rotor of the three-phase motor based on the second set of electrical parameters using an angle estimator;
add a phase shift to a second signal associated with the second set of electrical parameters to generate an updated second set of electrical parameters; and
determine, based on the updated second set of electrical parameters, a second set of backup control parameters for controlling a second amount of power delivered to the first set of windings.

15. The controller for the three-phase motor of claim 14, wherein the controller is further configured to:
control an amount of power delivered to the first set of windings using the command board;
identify a failure associated with the command board; and
control the amount of power delivered to the first set of windings using the backup board based on identifying the failure.

16. The controller for the three-phase motor of claim 13, wherein the first set of electrical parameters comprises three currents, each current associated with a respective winding of the first set of windings.

17. The controller for the three-phase motor of claim 13, wherein the first set of electrical parameters comprises three voltages, each voltage associated with a respective winding of the first set of windings.

18. One or more non-transitory, computer-readable media having stored thereon instructions that, when executed, cause a controller for a three-phase motor to:
on a command board of the controller:
receive a first set of electrical parameters associated with a first set of windings of a plurality of windings of the three-phase motor;
determine, based on the first set of electrical parameters, a first set of control parameters for controlling a first amount of power delivered to the first set of windings;
determine an angle of a rotor of the three-phase motor based on the first set of electrical parameters using an angle estimator;
add a phase shift to a first signal associated with the first set of electrical parameters to determine an updated first set of electrical parameters; and
determine, based on the updated first set of electrical parameters, a second set of control parameters for controlling a second amount of power delivered to a second set of windings.

19. The one or more non-transitory, computer-readable media of claim 18, wherein the instructions that, when executed, further cause the controller for the three-phase motor to:
on a backup board of the controller:
determine a second set of electrical parameters associated with the second set of windings of the plurality of windings of the three-phase motor;
determine, based on the second set of electrical parameters, a first set of backup control parameters for controlling a first amount of power delivered to the first set of windings;
determine a backup angle of the rotor of the three-phase motor based on the second set of electrical parameters using an angle estimator;
add a phase shift to a second signal associated with the second set of electrical parameters to generate an updated second set of electrical parameters; and
determine, based on the updated second set of electrical parameters, a second set of backup control parameters for controlling a second amount of power delivered to the first set of windings.

20. The one or more non-transitory, computer-readable media of claim 19, wherein the instructions that, when executed, further cause the controller for the three-phase motor to:
control an amount of power delivered to the first set of windings using the command board;
identify a failure associated with the command board; and
control the amount of power delivered to the first set of windings using the backup board based on identifying the failure.
